(19) United States
(12) Patent Application Publication
(10) Pub. No.: US 2026/0023390 A1
(43) Pub. Date: Jan. 22, 2026

(54) MOBILE RESPONSE DEVICE FOR TRAFFIC MANAGEMENT AT FACILITIES

(71) Applicant: Frederick Mobile Instrumentation, LLC, Huntsville, AL (US)

(72) Inventors: Andrew F. Nichols, Madison, AL (US); Larry D. Frederick, Huntsville, AL (US)

(21) Appl. No.: 19/273,338

(22) Filed: Jul. 18, 2025

Related U.S. Application Data
(60) Provisional application No. 63/673,278, filed on Jul. 19, 2024.

(51) Int. Cl. G05D 1/633; G05D 107/70

(52) U.S. Cl. CPC G05D 1/633; G05D 2107/70

(57) ABSTRACT

Mobile response device (MRD) and methods and systems of using the same. Sets of MRDs are configured and deployed in a given facility, mounted to moving objects such as robots or autonomous vehicles, and/or worn by personnel. The MRD is compact and relatively low in cost to manufacture, incentivizing its wider use for increased overall safety at facilities, such as fulfillment facilities or warehouses configured with very narrow aisles (VNA) and open pedestrian zones shared with vehicles. The MRD is equipped with two tuned circuits to detect low frequency magnetic field pulses along perpendicular horizontal axes and a radio transmitter that transmits radio frequency signals when a low frequency magnetic field pulse has been detected, notifying the vehicle that generated the low frequency magnetic field pulse of the nearby presence of the MRD such that anti-collision measures can be initiated.

### FIELD OF THE DISCLOSURE

This disclosure relates to vehicular and pedestrian safety, traffic control and tracking at facilities.

### BACKGROUND

A variety of concepts have been conceived and tried that provide continuous tracking of moving vehicles and personnel throughout a facility in order to avoid workplace accidents, e.g., collisions with machinery, vehicles, and workers. Many of these safety and tracking systems are centralized and attempt to accomplish all of the interpretations of movements and calculations required to provide a safe working environment and track all of the physical and spatial information. There are many practical problems with these centralized approaches that limit their effectiveness. For example, the centralized approaches require placing the geometry of the facility into a centralized computer system and this geometry must be kept current, a job that is not always easy with frequent shifting locations of products and even parts of the facilities being moved from time to time. And, every item of interest, every vehicle, every person, every object that is relocated must be known and fed into the centralized system. An even more burdensome task is the making of judgements in advance about how to accurately interpret the changes in physical relationships of all these items, while trying to be certain that a safety related consideration is not overlooked or misunderstood. In addition, if there is a failure of the centralized safety and tracking system, then there is a total failure at the work site and all work must stop until the issues are addressed.

Many ideas have been considered for workplace safety and tracking and some have been successfully implemented. However, experience has shown that each developed idea tends to be effective to solve some specific problems or do specific jobs but tend to be ineffective or impractical to implement for solving other problems or doing other jobs. Attempts to combine many differing ideas into a composite system tend to be burdensome since each new development tends to require its own resources and support. For example, radio frequency identification systems, such as radio frequency identification (RFID) have been used to provide location awareness of hazardous environments. However, RFID technology cannot precisely be used to identify safety boundaries within an industrial or commercial environment because the RFID waves are too easily reflected by an environment typically filled with industrial equipment, for example, racks, trucks, loading equipment, and inventory, leading to multiple propagation paths and errors. As such, RFID is not sufficient accurate for precise tracking and for providing safety information.

U.S. Pat. No. 5,939,986, incorporated herein by reference in its entirety, disclosed the use of closed-loop, low frequency, magnetic fields to allow mining machines in underground mines to detect pedestrians and to warn both the pedestrians and the operators when they are in close proximity. Since then, other ideas have been disclosed that expanded and improved upon this idea for use in most types of industrial environments, and these ideas have been successfully implemented in new ways, that avert accidents and provide useful data about the equipment operations. These advances are described in detail in numerous Frederick patents, that are referenced in this disclosure.

### SUMMARY

In general terms, the present disclosure is directed to a compact mobile response device used for proximity detection in a facility.

In further general terms, the present disclosure is directed to a system of devices including one or more mobile response devices.

In further general terms, the present disclosure is directed to methods of using a mobile response device and systems incorporating one or more mobile response devices.

In one aspect, the present disclosure relates to proximity detection device of a vehicle, including: a radio frequency receiver; and a magnetic field generator configured to generate magnetic field pulses that can be detected by: (i) a facility marker module (FMM) having no more than one tuned circuit for detecting the magnetic field pulses; and (ii) a mobile response device (MRD) including a plurality of tuned circuits for detecting the magnetic field pulses, wherein the radio frequency receiver is tuned to a first frequency band to listen during a first time window to receive a response to the magnetic field pulses from the FMM; wherein the radio frequency receiver is tuned to a second frequency band to listen during a second time window to receive a response to the magnetic field pulses from the MRD, the second frequency band being different than the first frequency first band; and wherein the first time window and the second time window do not overlap.

In another aspect, the present disclosure relates to a traffic management system, including: the proximity detection device, FMM and MRD just described, wherein the plurality of tuned circuits includes no more than two tuned circuits.

In another aspect, the present disclosure relates to a traffic management system configured for a facility having a plurality of aisles and a plurality of vehicles, including a plurality of proximity detection devices mounted to different vehicles of the plurality of vehicles; a plurality of facility marker modules (FMMs) mounted to different aisles of the plurality of aisles, each FMM including no more than one tuned circuit, a processor and a UHF transceiver, each FMM being configured to transmit signals using the processor and the UHF transceiver in response to receiving, by the tuned circuit, magnetic field pulses generated by one of the plurality of proximity detection devices; and a plurality of mobile response devices (MRDs), each MRD being mounted to a person or to an autonomous mobile robot, each MRD including a plurality of tuned circuits for detecting the magnetic field pulses, wherein the plurality of proximity detection devices are configured to determine, based on signals received from the plurality of FMMs, whether the different vehicles are in the same aisle of the plurality of aisles; and wherein the plurality of proximity detection devices are configured to determine, based on signals received from the plurality of MRDs, whether the plurality of proximity detection devices and the plurality of MRDs are within predefined distances of one another.

In another aspect, the present disclosure relates to a mobile response device (MRD), including: a housing defining an interior volume of the housing; a plurality of tuned circuits positioned in the interior volume and configured to detect magnetic field pulses along multiple, perpendicular axes; a radio frequency transceiver operatively coupled to the plurality of tuned circuits and positioned within the interior volume; and a battery positioned within the interior volume and operatively coupled to the plurality of tuned circuits and to the radio frequency transceiver to provide power thereto, wherein the exterior housing occupies a volume of less than 8 cubic inches.

The foregoing aspects are not limiting. Additional aspects of the present disclosure are described below.

### BRIEF DESCRIPTION OF THE DRAWINGS

FIG. 1 is a schematic representation of an example facility with vehicles and aisles, including a traffic management system according to an embodiment of the present disclosure.

FIG. 2 is a schematic representation of an example facility with vehicles and aisles, including a traffic management system according to a further embodiment of the present disclosure.

FIG. 3 is a schematic representation of an embodiment of a mobile response device (MRD) of the traffic management system of FIG. 1 and of FIG. 2.

FIG. 4 is a schematic representation of another embodiment of a MRD of the traffic management system of FIG. 1 and of FIG. 2.

FIG. 5 depicts example use cases for personnel of the system of FIG. 1 and FIG. 2 to wear a MRD of the system of FIG. 1 and FIG. 2.

FIG. 6 depicts an example mobile object of the system of FIG. 1 and FIG. 2 to which a MRD of the system of FIG. 1 and FIG. 2 can be mounted.

FIG. 7 depicts an example tractor-trailer of the system of FIG. 1 and FIG. 2 to which a MRD of the system of FIG. 1 and FIG. 2 can be mounted.

FIG. 8 schematically depicts magnetic fields generated by magnetic pulses surrounding a vehicle of the system of FIG. 1 and FIG. 2 that includes a proximity detection device of FIG. 1 and FIG. 2.

FIG. 9 is a schematic representation of a communications protocol of a proximity detection device of the traffic management system of FIG. 1 and FIG. 2.

FIG. 10 is a schematic representation of components of the proximity detection device of the vehicle of FIG. 8.

FIG. 11 is a schematic representation of an embodiment of a facility marker module (FMM) of the traffic management system of FIG. 1 and FIG. 2.

### DETAILED DESCRIPTION OF THE INVENTION

Like numbers refer to like parts throughout the several drawings.

As e-commerce continues to expand, new high-density warehouses continue to open. Labor shortages have forced a change from the historic approach used to maintain qualified equipment operators, and this change is creating challenges for companies to find, train, and maintain qualified operators. As the operator base becomes less experienced and the warehouses or production facilities are becoming more congested, the risk of collision increases and so does the need for operator assistance systems to accurately detect personnel in close proximity to mobile equipment such as forklifts. These systems are clearly defined in the Frederick patents, described below.

Many of these facilities are also configured such that the majority of personnel are intended to be separated from forklift traffic by physical barriers, procedures, or other containment solutions. However, occasionally a worker may wander into the path of a forklift, or a forklift may enter a pedestrian-only area for a specific task. These unexpected interactions can surprise forklift operators so that they do not react quickly enough to prevent an accident. This creates a need for a solution for detecting personnel that occasionally are near manned or autonomous mobile equipment.

Similarly, Automated Guided Vehicles (AGVs) and Autonomous Mobile Robots (AMRs) have introduced a new safety problem. Experience has shown that operators do not always correctly anticipate the movements of AGVs and strike them with the forklift that they are driving. Also, AGVs may exit from aisles into roadways, and operators, not anticipating the presence of the AGV, are more at risk of collision with the AGV. This equipment safety concern can be even greater when interacting with AMRs because they may have a very low profile and are not easily seen. Damage to AGVs or AMRs are often very costly. There is a need to alert forklift operators when there are AGVs or AMRs in their vicinity because otherwise, they may fail to sufficiently respond quickly enough to avoid striking the autonomous equipment. This is especially important when the equipment is not visible because of obstructions such as metal storage racks, products, or facility elements.

Additionally, autonomous forklifts based on manned forklift platforms that have been converted to autonomous operation must avoid collisions with structures, each other, manned equipment, and other autonomous equipment running different guidance systems. The forklifts are typically equipped with multiple guidance systems and sensors to effectively operate. However, the unpredictability of other AMRs within the facility operating around the autonomous forklift can present detection challenges since they do not communicate. Rather, the forklift can only recognize an obstacle via the forklift's sensors. However, these sensors, even in combination, do not have the ability to detect through obstructions. This creates a need for collision avoidance between autonomous vehicles around rack ends, between stacks of goods, and other obstacles.

Existing proximity detection devices (also referred to herein as proximity detection systems, or PDSs) are particularly effective because of their ability to detect through obstructions and other line-of-sight blocking obstacles, and to warn operators with critical proximity information even when visibility is compromised. Cameras can be effective and have been proven in cases such as automobiles where visibility is predictable. This can be true in some warehouse roadways as well. However, camera-based or vision-based systems are hindered by obstructions and usually require clear line-of-sight to function effectively. Cameras are limited in performance in environments with temperature shifts such as cold storage or dusty environments that prevent clear images. Additionally, the camera mounting configuration for full 360-degree coverage is challenging due to location of masts, and other forklift elements. This often results in only one direction implementation of the camera. RF-ranging technologies can also be obstructed, or signals may be distorted or reflected, thus reducing accuracy and/or are prone to creating false warnings.

A device and methods of usage is hereby presented that allows detection capabilities optimized for the modern industrial environment. The mobile responder device (MRD) disclosed will be easily integrated and worn on personnel, utilize hibernation capabilities for extended battery life, and integrate into the existing system architecture of traffic management systems including those described in the Frederick patents using pulsed magnetics, sometimes in conjunction with cameras. A version of the MRD will also be described that is optimized for use on Autonomous Vehicles (AV) and is powered by that vehicle.

VNA-configured facilities (also referred to herein as VNA-configured workplaces), such as warehouses, distribution centers, and the like, are often equipped with traffic management systems for preventing or minimizing collisions between vehicles (e.g., forklifts, pick and place trucks, other trucks and other vehicles moving around on the floor of the facility).

Advances in available ultra high frequency (UHF) radios allows for quick configuration at multiple radio frequencies and communication at high data rates required to send necessary information between devices. This information can include aisle location and other vehicle specific information. This enables the system architecture to support the load of many vehicles, personnel, and other mobile objects along with sending necessary information. Concurrency is also used to identify the vehicle generating the magnetic field by the vehicle receiving such that the receiving truck can determine if they are in the same aisle, and subsequently signal the vehicle/operator.

Low frequency magnetic fields have been used to produce safety zones, safety markers, warnings, and automatic actions that protect personnel from being hit by mobile machines. This technology has been proven effective for providing proximity detection systems (PDS) and collision avoidance systems (CAS) (PDS/CAS) in many industrial environments. For purposes of this disclosure, a PDS system can be a CAS system in some cases. The high reliability and precision of these low frequency magnetic field systems has led to a variety of system configurations and devices that protect pedestrians, prevent collisions between vehicles and/or machines, and prevent collisions with facility items. Examples of these devices are disclosed in U.S. Pat. No. 7,420,471 (the '471 patent), U.S. Pat. No. 8,169,335 (the '335 patent), U.S. Pat. No. 8,552,882 (the '882 patent) U.S. Pat. No. 8,232,888 (the '888 patent), U.S. Pat. No. 8,446,277 (the '277 patent), U.S. Pat. No. 8,847,780 (the '780 patent), U.S. Pat. No. 8,710,979 (the '979 patent), U.S. Pat. No. 8,810,390 (the '390 patent), U.S. Pat. No. 9,081,046 (the '046 patent), U.S. Pat. No. 9,280,885 (the '885 patent), U.S. Pat. No. 9,822,927 (the '927 patent), U.S. Pat. No. 10,591,627 (the '627 patent), U.S. Pat. No. 11,221,428 (the '428 patent), and U.S. Pat. No. 11,726,226 (the '226 patent), International PCT application publication number WO2021/194904 (the '904 publication), International PCT application publication number WO2022/174111 (the '111 publication) and International PCT Patent Application No. International PCT Patent Application No. PCT/US2023/071612 (the '612 application), and International PCT Patent Application No. PCT/US2025/010453 (the '453 application), which patents, publications, and applications are herein referred to collectively as the “Frederick patents,” the disclosures of which are incorporated herein by reference in their entireties.

The Frederick patents have been used successfully on, for example, fork trucks, loaders, top picks, floor sweepers, tractors, cranes, and other types of machinery. The systems of the present disclosure can be applied to these types of vehicles and others. The Frederick patents describe the useful properties of low frequency magnetic fields that allow for precise, effective proximity detection, even when the source and the sensing device are separated by a wide range of materials and objects. Non-metallic materials essentially have little effect on these fields and even metal objects between the source and detection do not have a significant effect. Effects from multi-path propagation is also avoided. The location of magnetic field generators and detectors are not constrained in the same way that optical devices, like cameras, are, which is important in typical industrial settings line of site is not always available. Line of sight is not required for disclosed basic PDS functionality, as is explained in the mentioned Frederick patents. Being able to not rely on line of sight is also beneficial to FMMs, tracking, and reporting.

The existing pulsed low frequency magnetic field PDS systems on mobile equipment disclosed in various Frederick patents used in conjunction with artificial intelligence-driven cameras are effective in wide open areas for detecting personnel without a wearable detection device. This solution is limited to line of sight but creates an additional layer of proximity detection—especially in heavily populated facilities where personnel may wander from their desired, marked-off locations away from forklift traffic.

Systems of the present disclosure can utilize facility marker modules (FMMs). FMMs are described in the '612 application and the '453 application, the contents of which are incorporated by reference in their entirety. These patent applications describe the use of FMMs to identify points of interest (POIs) throughout a facility, including using FMMs to mark each very narrow aisle in a warehouse. These patent applications also describe systems of FMMs that are used to allow tracking of the vehicles in aisles without communications or additional inputs from the vehicles, by utilizing existing proximity detection systems (PDS) of the vehicles and long-life battery powered FMMs positioned in different aisles and communicating in a precisely timed manner on multiple RF frequencies. The communication protocol maintains adequate bandwidth to handle a densely populated warehouse with many pieces of mobile equipment.

A FMM can be a battery-operated device, having a long life made possible through a hibernation circuit. The hibernation circuit enables the FMM to remain in a hibernated condition until a vehicle, equipped with a pulsed, low frequency, magnetic field, approaches close enough to the FMM for the magnetic field from the vehicle to “wake up” (e.g., activate) the FMM so that it can send signal containing relevant information to the PDS of the approaching vehicle.

The information can be transmitted to the PDS of the approaching vehicle by an ultra-high frequency (UHF) transceiver of the FMM, in response to a magnetic pulse from the PDS. After the transfer of information has been completed, in some examples the FMM returns to hibernation until the next vehicle arrives that triggers the FMM out of hibernation. Alternatively, the FMM can be programmed to continue transmitting until the magnetic field from the vehicle no longer reaches the FMM.

FMMs can serve as aisle markers, e.g., markers of very narrow aisles (VNAs). The transmitted signals by the FMMs can cause vehicles to automatically stop at the ends of aisles associated with the FMMs. The FMMs can also track and analyze vehicle entry to, and exit from, POI aisles in facilities, such as distribution centers. As end of aisle markers, FMMs can be configured to allow for special right of way intersection logic with automated enforcement by automated slowing and/or stopping of vehicles at or near the ends of POI aisles.

The signal sent by the FMM includes an identifier (also referred to as an identification or ID) of the aisle or other POI (e.g., truck loading portal) and any other relevant information. The PDS of the vehicle stores the aisle ID learned from the FMM in its memory until the vehicle exits the aisle (or other POI). In the meantime, the ID is used in communicating with other vehicles.

When the PDS of a vehicle communicates with a PDS of another vehicle (e.g., another vehicle having a PDS in an aisle state), it sends a concurrent data packet with the aisle ID that it has stored. If both vehicles have the same aisle ID (and therefore are in the same aisle) an alerting signal is provided to the vehicle/operator of at least one of the vehicles and, typically at least the vehicle/operator that more recently entered the aisle.

If the aisle IDs of the two vehicles do not match, then no alerting signal is provided and thereby a nuisance alert is avoided.

FMMs are designed with a single tuned circuit for detecting pulsed magnetic fields along a single axis. This is because FMMs are positioned to detect vehicles, e.g., forklifts that are constrained to a single axis of movement, e.g., within a very narrow aisle or adjacent a truck portal.

The previously disclosed FMM's described in the '612 application and the '453 application are designed to be configurable, long battery life responders with capabilities to alert operators as they approach marked zones. However, as just described they are limited in detection sensitivity since they have just one tuned circuit for detection of low frequency magnetic field pulses along a single axis (which is ideal for avoiding collisions along a single axis of movement such as within an aisle). They also have a drawback of being sized for physical mounting to facilities-not for wearability. Because FMMs have just single tuned circuit and detection axis, the FMMs require fixed locations within the facility and would not operate properly on moving objects. There exists a need for a device that is portable, able to detect when worn in various configurations, and is reliable regardless of visibility.

A solution to these problems with FMMs is mobile responder device (MRD) according to the present disclosure. The MRD is a small, pulsed magnetic field detection device that can worn by personnel, installed on moving carts or tractor-trailers, or installed on an autonomous vehicle, which helps equipment operators to avoid collisions. Due to the shape and variation in size of AVs, training cameras to detect is a difficult process, plus the addition of the movements around corners creates a need for the MRD. This device allows for full 360-degree detection around the equipment. Additionally, it also allows the system to remotely monitor the interactions between equipment and these devices. The MRD automatically provides a signal back to the PDS on the mobile equipment (e.g., a forklift) with the proximity information. The MRD must be able to accurately respond to all mobile equipment and personnel that are in its close proximity. In addition, mobile equipment (e.g., manned and/or autonomously operated forklifts) within the facility must be able to simultaneously detect multiple MRDs.

The MRD also interacts with facility-mounted pulsed magnetic field generators that can control or limit access to areas. The MRD allows for data to be transmitted and stored allowing for monitoring of number and timing of personnel entering and exiting. The MRD version for mobile carts and semi-trailers can also be used to monitor the timing of entries and exits into a facility property by the tagged equipment.

According to an embodiment of a MRD of the present disclosure, the MRD is a portable, user-worn, battery-operated device, having a long life made possible through a hibernation circuit. This device stays in a hibernated condition until mobile equipment equipped with a pulsed, low frequency magnetic field, approaches close enough to the MRD for the magnetic field from the mobile equipment to wake up the MRD so that it can send information to the PDS. The information is transmitted by a UHF transceiver in response to each magnetic pulse from the PDS. It is programmed to continue transmitting with other reporting features that are available, providing valuable data, presented in a user-friendly format for managers to use and operational efficiency.

Additionally, the system, due to the addition of the MRD, can enhance collision avoidance capabilities for autonomous forklifts. The autonomous forklifts can be equipped with a pulsed magnetic field generator or multiple pulsed magnetic field generators that are constructed to be easily integrated. Meanwhile, the AMRs are equipped with MRDs. If equipped with multiple MRDs, this allows for directional alerts to be provided to the control system of the autonomous forklift, preventing collisions with hard-to-detect AMRs or structures as well. The autonomous forklifts are also provided with the necessary information to move away from other detected equipment.

The MRD of the present disclosure may be used for purposes other than collision avoidance, such as more accurately monitoring traffic into and out of a facility, as well as event frequency and location patterns. In order to accomplish these purposes, the device must detect the mobile equipment (e.g., the PDS of a forklift) and transmit information back to the mobile equipment. This includes accurately recording, for example, data identifying which forklift loaded which tractor-trailer.

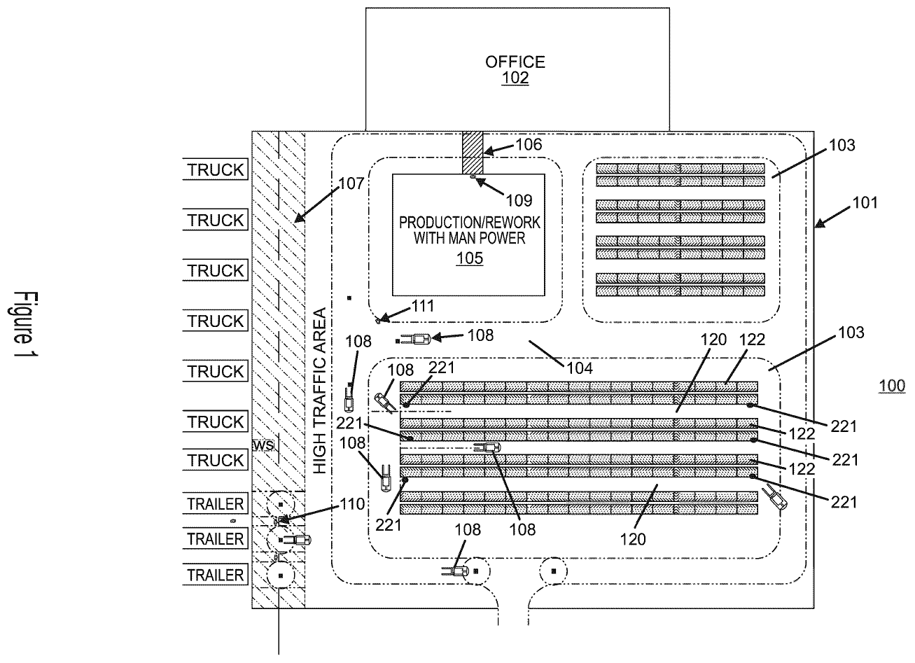

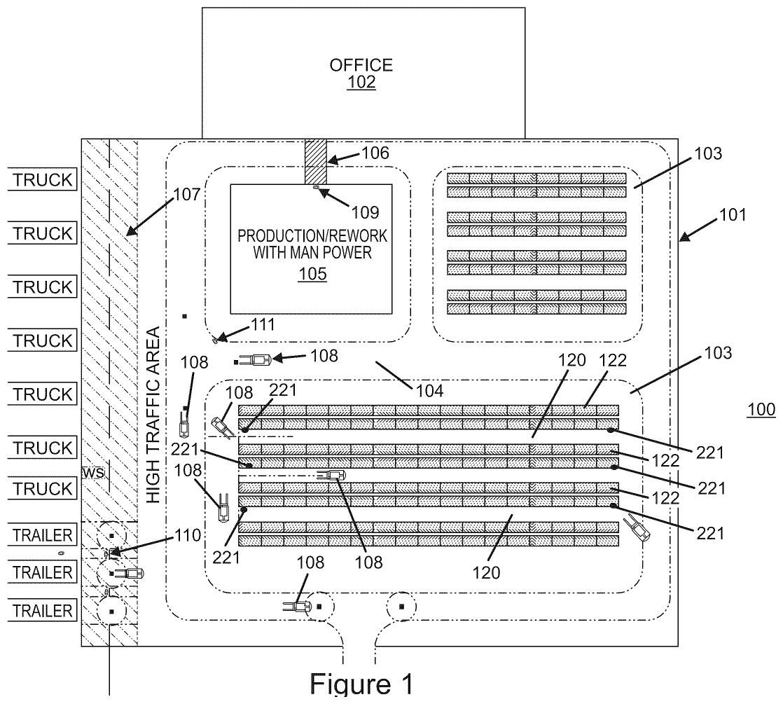

FIG. 1 is a schematic representation of an example facility 100 with vehicles and aisles 120, including a traffic management system according to an embodiment of the present disclosure.

The aisles 120 are defined by racks 122. Forklifts 108 navigate the racks 122 via the aisles 120.

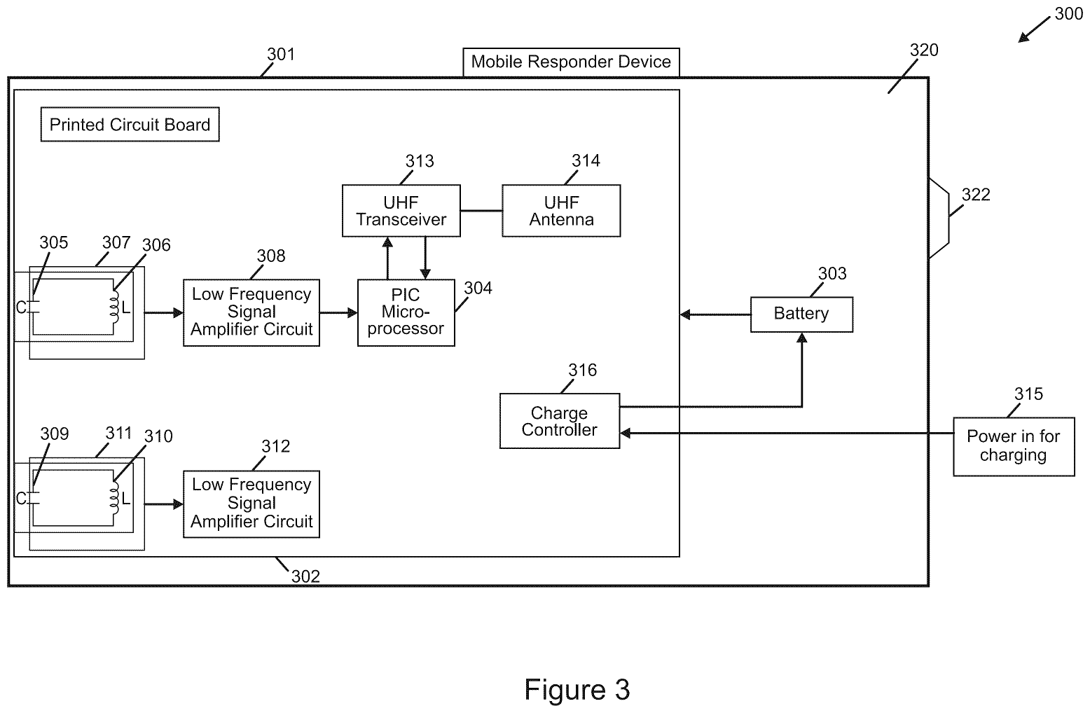

FIG. 1 represents, in a simplified fashion, typical activities and situations in a distribution center 100 where personnel 109 are working in a defined area 105 but sometimes must walk through the rest of the facility 101 or across a walkway 106 to reach an office 102. The walkway 106 crosses a roadway 104 where forklifts 108 are used. Personnel 109, 110, 111 should be detected if they enter roadways 104. This is made effective by use if of the camera-assisted PDS mounted to each forklift 108 and the MRD worn by each of the personnel 109, 110, 111. The construction of the MRD is described further in FIG. 3.

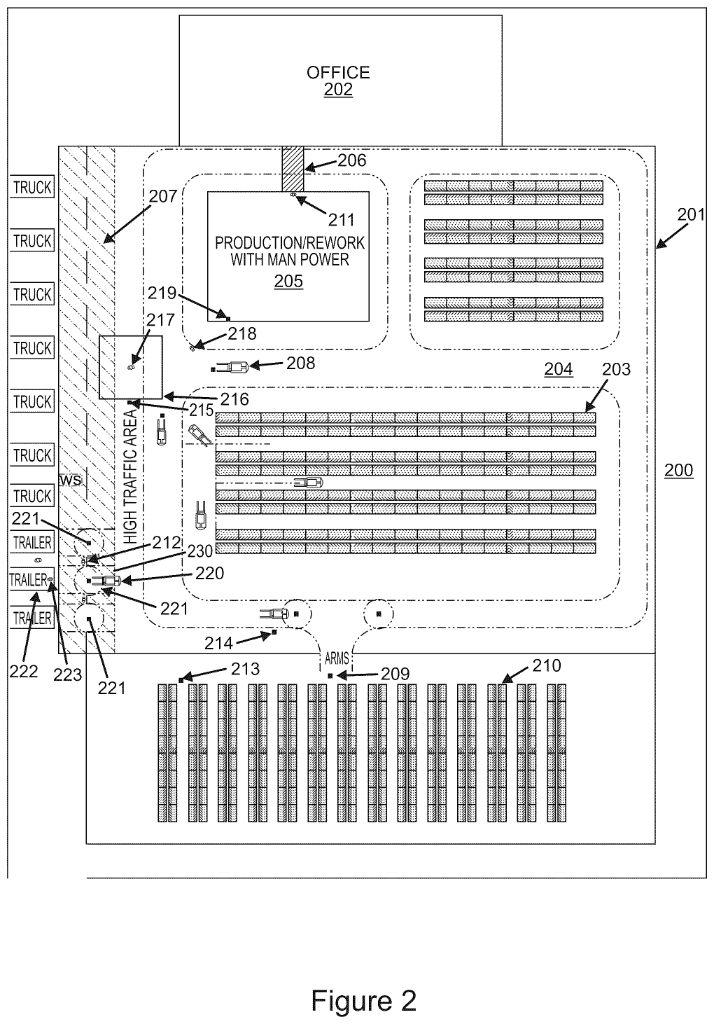

FIG. 2 is a schematic representation of an example facility 200 with vehicles and aisles, including a traffic management system according to a further embodiment of the present disclosure.

FIG. 2 represents, in a simplified fashion, typical activities and situations in a distribution center 200 with the addition of an AGV storage system 209 where personnel are working in a defined area 205, 216 but sometimes must walk through the rest of the facility 201 or across a walkway 206 where forklifts 208, 220 are used on roadways 204. Also, the AGVs 209, 213, 215, 219 move in various ways sometimes under racking-making it difficult for detection by radio signals or cameras due to the unpredictability of shape and limited difference from the surrounding environment. Additionally, the docking area 207 can be busy, and tracking of which equipment is loading which trailer is important to ensure proper delivery of goods. The portals are already marked with FMMs 221. Similarly, FMMs can be mounted to the racks defining the aisle. This identifies the portal (or aisle) and the time a forklift enters or exits. FMMs 221 are also mounted to the racks of the aisles.

A MRD 223 is mounted to a tractor-trailer 222 stationed at one of the portals 230 of the facility 200. This MRD 223 allows for more exact information to be exchanged between the FMM 221 and the PDS of the forklift 220, as well between the MRD 223 and the PDS of the forklift 220 to record that goods made it to the correct trailer through the correct portal from the forklift 220.

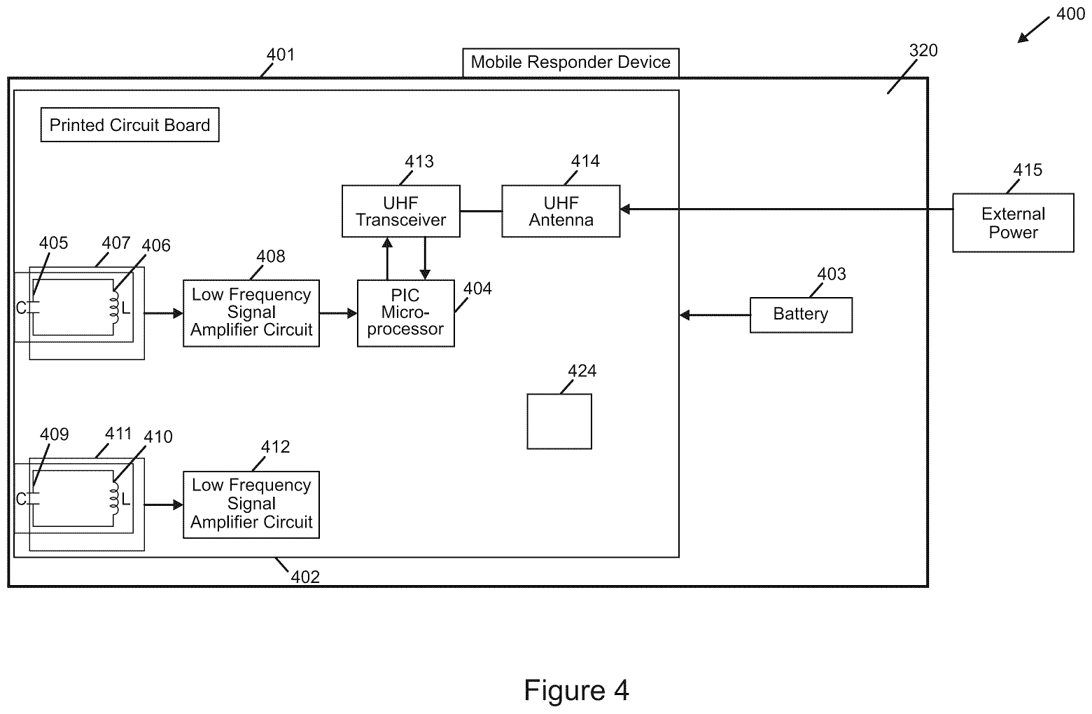

Pulsed, low frequency magnetic fields generated by the PDS's of the forklifts are very stable and precise, their shape not significantly affected by most materials and objects. Discrete metal objects, non-metallic objects, and most other items pass the magnetic fields so that they “see through” almost everything. The construction of these devices will further be described in the description of FIG. 4, however they are battery powered or powered by the AGV or trailer, concealable under the covers or under the chassis which is possible due to the pulsed low frequency magnetic field properties.

FIG. 3 is a schematic representation of an embodiment of a mobile response device 300 (MRD) of the traffic management system of FIG. 1 and FIG. 2. The MRD 300 can correspond to any of the MRD's of FIG. 1 or FIG. 2.

The MRD 300 includes a housing 301 defining an internal volume 320. The housing 301 is compact, to facilitate its wearability and mountability to different areas of a person or robotic vehicle. The housing 301 can include a mounting structure 322 for mounting the housing 301 to a mobile object (such as a person or robotic vehicle). The mounting structure 322 can include one or more of an adhesive, a clip, a strap, a pin, and a hole for receiving a fastener.

In some examples, to facilitate its wearability and mountability to different areas of a person or robotic vehicle, the MRD 300 weighs less than 5 ounces, or less than 4 ounces. In some examples, the housing 301 is constructed of a polymeric material.

In examples, at least one dimension of the housing 301 has a maximum length of less than one inch. In some examples, at least one dimension of the housing 301 has a maximum length of less than 0.8 inches. In some examples, at least one dimension of the housing 301 has a maximum length of about 0.6 inches or less.

In some examples, its wearability and mountability to different areas of a person or robotic vehicle, the housing 301 (and the MRD 300 overall) occupies a volume that is less than 8 cubic inches, or less than 6 cubic inches, or less than 5 cubic inches. In some examples, the housing 301 (and the MRD overall) occupies a volume of about 4.8 cubic inches or less.

The interior volume 320 contains a circuit board 302 populated with two capacitors 305, 309 and inductors 306, 310 forming, respectively, two tuned circuits 307, 311 for reception of low-frequency magnetic fields generated by a magnetic field generator of a PDS along two perpendicular horizontal axes. Having two detection axes provided by two tuned circuits allows the PDS of a fork truck to locate a MRD of a mobile object for which there is a danger of collision in open space regardless of the particular orientation of the mobile object relative to the forklift, rather than only in the confines of an aisle or portal passage, as would be permitted by a single tuned circuit.

When a low frequency signal is received, it is read and interpreted by the processor 304 and then, if a valid signal, the processor responds with a timed UHF transmission via the UHF transceiver 313 and antenna 314. The frequency of the UHF transceiver may vary.

The MRD is powered by an on-board battery 303. The battery 303 is rechargeable via external power 315. The charge is controlled by an onboard charge controller 316. A hibernation circuit as described herein may be operatively coupled to the battery 303, such that no power is consumed unless one of the tuned circuits is detecting a magnetic field pulse.

Exact construction of the components housed in the interior volume 320 may vary. However, because the MRD does not include its own alert system for alerting, e.g., with sounds and/or a lights, a person wearing the MRD, the number of components is reduced, allowing the MRD to be advantageously sized compactly. Likewise, the MRD is equipped with no more than two tuned circuits, further allowing the MRD to be advantageously sized compactly.

FIG. 4 is a schematic representation of another embodiment of a MRD 400 of the traffic management system of FIG. 1 and of FIG. 2. The MRD 400 can correspond to any of the MRD's of FIG. 1 or FIG. 2. The MRD 400 can have the same size and weight constraints as described above in connection with the MRD 300.

The MRD 400 includes a housing 401 (like the housing 301) that contains a circuit board 402 populated with two capacitors 405, 409 and inductors 406, 410 forming, respectively, two tuned circuits 407, 411 for reception of low-frequency magnetic fields. When a low frequency magnetic field signal is received, it is passed through an amplification circuit 408, 412, then it is read and interpreted by the processor 404. Then, if a valid signal, the processor responds with a timed UHF transmission via the UHF transceiver 413 and antenna 414. The frequency of the UHF transceiver may vary. The MRD 400 is powered via a battery (403).

External power 415 can be supplied to the MRD 400, e.g., from a mobile robot or autonomous vehicle or tractor-trailer on which the MRD 400 is mounted, eliminating the need for battery charging. In some embodiments, the MRD 400 can include an output or communication base 424 to provide data to the AGV for slow or stop functions based on the signals received and sent between the MRD 400 and other vehicles and the possibility of collisions based on those signals.

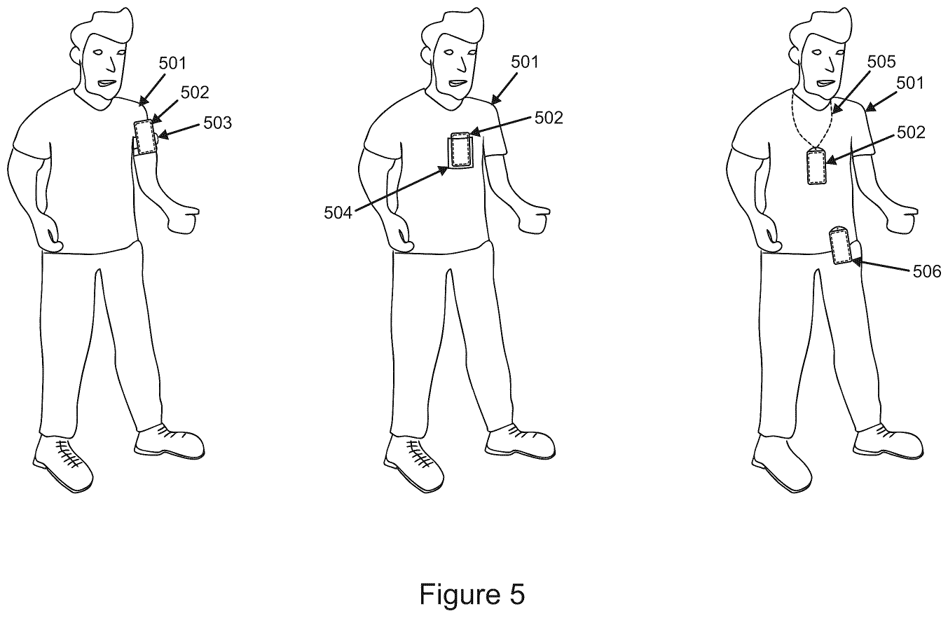

FIG. 5 depicts example use cases for personnel of the system of FIG. 1 and FIG. 2 to wear a MRD of the system of FIG. 1 and FIG. 2. In particular, FIG. 5 shows a person 501 equipped with the MRD 502. The MRD 502 can correspond to the MRD 300 described above. Multiple options for wearing the device (e.g., via the mounting structure 322) are shown including by armband 503, in a shirt or vest pocket 504, integrated belt clip 506, or on a lanyard 505. Other mounting components are possible.

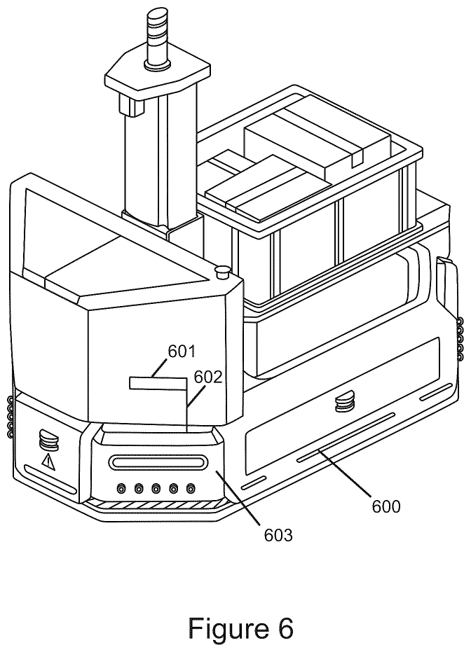

FIG. 6 depicts an example mobile object of the system of FIG. 1 and FIG. 2 to which a MRD of the system of FIG. 1 and FIG. 2 can be mounted. FIG. 6 shows the MRD to AFV interface. In particular, the AV 600 has the MRD 601 (which can correspond to the MRD 400) installed thereon. The MRD 601 can be installed under the equipment panel or on the exterior, since magnetic field pulses are not blocked by such structures. There is a cable 602 for providing power to the MRD 601 from the AV 600. The MRD 601 can include an output or communication base to provide data to the AV for slow or stop functions as described herein.

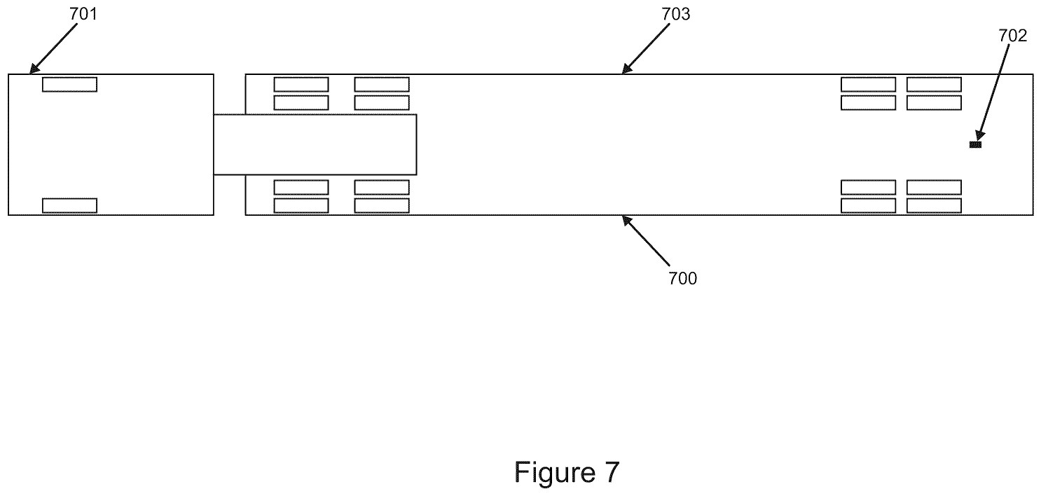

FIG. 7 depicts a bottom view of an example tractor-trailer 700 of the system of FIG. 1 and FIG. 2 to which a MRD of the system of FIG. 1 and FIG. 2 can be mounted. The tractor-trailer includes a tractor 701 and a trailer 703. The trailer 703 can correspond to the trailer 222. A MRD 702 is mounted at a bottom of the trailer 703. The MRD 702 can correspond to the MRD 300 or the MRD 400 (and receive power from the tractor-trailer 700).

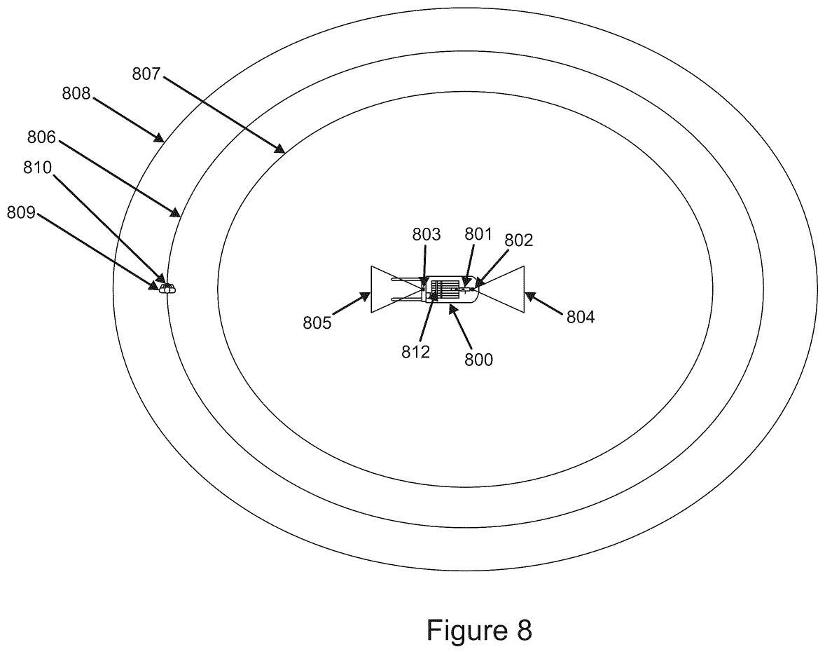

FIG. 8 schematically depicts magnetic fields generated by magnetic pulses surrounding a vehicle of the system of FIG. 1 and FIG. 2 that includes a proximity detection device of FIG. 1 and FIG. 2. A PDS 801 is mounted to a forklift 800. The forklift 800 can correspond to any of the forklifts described herein. The forklift is also equipped with cameras 802, 803 and warning modules 811, 812. The PDS 801 is configured to generate pulsed magnetic field shapes corresponding to each of a warning zone 808 around the PDS 801 and danger zone 807 around the PDS 801, the danger zone being closer to the PDS 801 than the warning zone. These zones are configurable via tuning of the PDS 801 and/or tuning of the tuned circuits of the receiving devices. The field of view 804 of the front camera 802 is shown. The field of view 805 of the rear camera 803 is shown. These fields of view 804 and 805 are adjustable and configurable.

In addition, the MRD pulsed magnetic field detection zone 806 is shown. A person 809 is shown wearing the MRD 810. The MRD 810 can correspond to the MRD 300 described above. In this example, the size of the MRD detection zone 806 is smaller than the size of the warning zone 808 but larger than the size of the danger zone 807. The MRD detection zone 807 can be configured differently.

Visual data from the cameras 802 and 803 can supplement or augment the responses received by the PDS 801 from magnetic field detection devices to further assist the forklift 800 in avoiding collisions.

The PDS 801 will only be caused to generate an audible and/or visible alert (e.g., via the warning modules 811, 812) and/or caused to take a collision avoidance action (e.g., by slowing, stopping or changing direction using a control interface between the PDS 801 and movement controller of the forklift 800) with respect to the person 809 if the person 809 is detected, via an RF signal received from the MRD 810 and in response to the tuned magnetic field pulse generated by the PDS 801, to be within the predefined MRD detection zone 806.

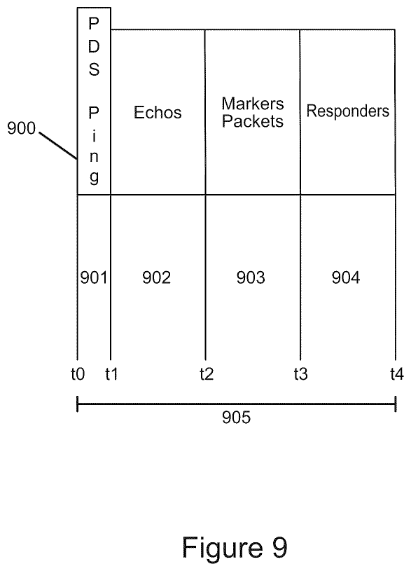

FIG. 9 is a schematic representation of a communications protocol of a proximity detection device of the traffic management system of FIG. 1 and FIG. 2. In particular, FIG. 9 is a schematic representation of the communication timing between a PDS and different detection devices. The sequence is started with a low frequency magnetic pulse or ping 900 from the PDS that is of a period 901. Then the PDS listens on a predefined UHF frequency in three windows each for a preset period. These frequencies may vary for each period or even within a defined period. The periods are defined for echoes in a time period 902 (for receiving RF signals from devices other than FMMs and MRDs), subsequently for FMMs in a time period 903, and subsequently for MRDs in a time period 904, representing three discrete non-overlapping time periods or windows 902, 903 and 904. This total communication process lasts a total period 905. The time periods can be in different orders (e.g., the MRD window 904 can come before the FMM window). The different time periods can be adjusted to various lengths depending on the desired data transfer and transfer rates. The total communication protocol timing 905 could range from about 8 milliseconds to about 22 milliseconds.

During the time window 903, the radio frequency receiver of the PDS 801 can be tuned to a first frequency band to listen during the time window 903 to receive responses to the magnetic field pulses generated by the PDS 801 from one or more FMMs.

During the time window 904, the radio frequency receiver of the PDS 801 is tuned to a second frequency band to listen during the time window 904 to receive responses to the magnetic field pulses generated by the PDS 801 from one or more MRDs, the second frequency band being different than the first frequency first band.

The frequency bands corresponding to the different time windows can also correspond to (e.g., have ranges that extend to) different zones around the PDS 801, such as a warning zone, a danger zone, and a MRD zone, as described herein.

In some examples, the time windows 903 and 904 do not overlap to allow the PDS to differentiate between different types of detection device.

In some examples, none of the time windows 902, 903 or 904 overlap to allow the PDS to differentiate between different types of detection devices.

In some examples, the time window 903 begins when the time window 902 ends to minimize the total signal protocol time.

In some examples, the time window 904 begins when the time window 903 ends to minimize the total signal protocol time.

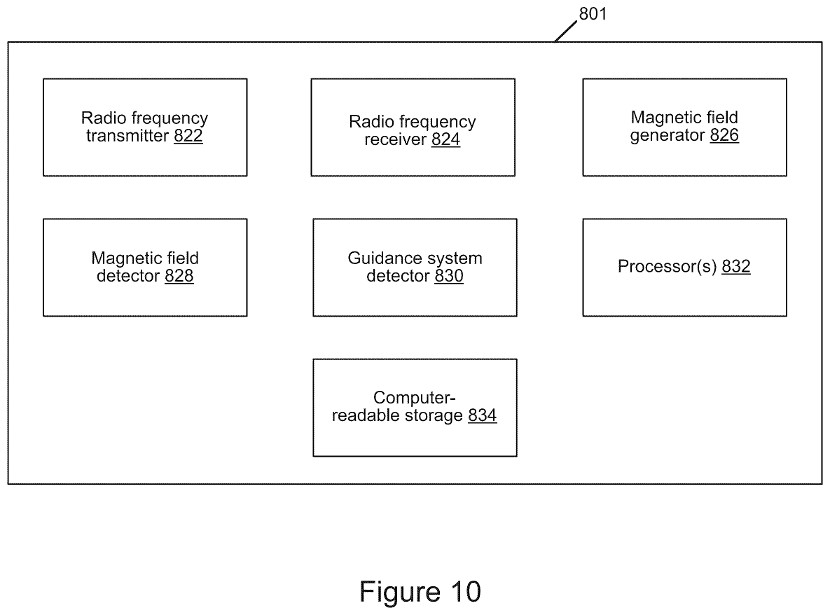

FIG. 10 is a schematic representation of components of the proximity detection device (or PDS) 801 of the vehicle of FIG. 8.

The PDS 801 is configured to be installed on a vehicle, such as any of the forklifts described herein. The PDS 801 includes components configured to perform the functions of the PDS described herein. These components include a radio frequency transmitter 822, a radio frequency receiver 824, a low frequency magnetic field generator 826, a low frequency magnetic field detector 828, one or more processors 832, computer readable storage 834, which can include non-transitory computer readable storage that stores instructions that can be executed by the one or more processors 832, and in certain examples, such as vehicles that utilize a guidance of a VNA facility, a guidance system detector 830.

The radio frequency transmitter 822, for example, is configured to generate and transmit (also referred to herein as send) UHF signals.

The radio frequency receiver 824, for example, is configured to receive UHF signals, such as from PDS's of other vehicles or from FMMs or from MRDs sending signals.

The magnetic field generator 826, for example, is configured to generate the magnetic field pulses described herein. The generator 826 can be calibrated to limit the range of the generated pings as described above to establish different sized zones around the PDS 801.

The magnetic field detector 828, for example, is configured to detect low frequency magnetic fields, such as magnetic field pings generated by PDSs of other vehicles.

The guidance system detector 830 is configured to detect external triggers of a guidance system in the facility and, upon detection, engage the vehicle carrying the PDS 801 into the guidance system by monitoring the position of the vehicle relative to a guide path and generate signals that can be passed to the vehicle controller to maintain the vehicle on the guide path.

The processor(s) 832, via circuitry and/or network interfaces via a network (e.g., a Cloud, the Internet), are configured to receive inputs generated by the components 822, 824, 826, 828 and 830, in conjunction with one or more software modules containing computer-readable instructions stored on the storage 834, perform various functions of the PDS 801 described herein, such as storing an aisle ID received in a data packet from a FMM, comparing a stored aisle ID to another aisle ID received from a PDS of another vehicle and ensuing signaling functions, causing the transmitter 822 or the generator 826 to generate and transmit a signal, receiving and processing RF signals from MRDs, causing a controller of the vehicle to generate an alert or to cause the vehicle to slow down, stop, change direction based on the signals received, and the like.

The computer-readable storage 834 stores computer-readable instructions executable by the processor(s) 832. The storage 834 can include any of a multitude of different types of memory.

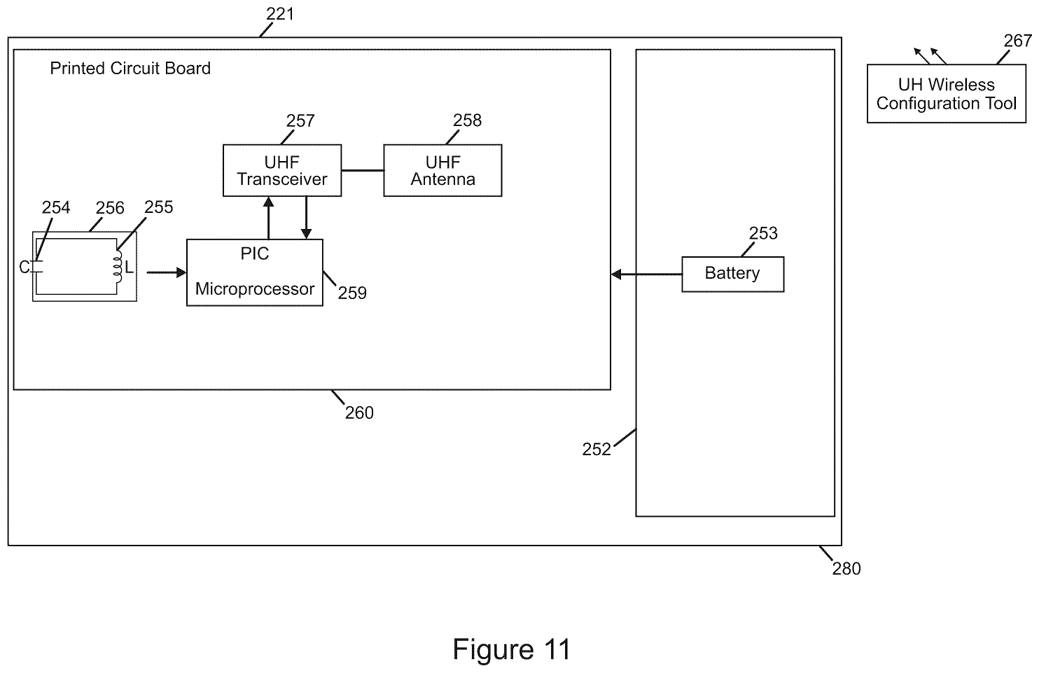

FIG. 11 is a schematic representation of an embodiment of a facility marker module (FMM) of the traffic management system of FIG. 1 and FIG. 2. The FMM can correspond to the FMM 221, for example.

The FMM 221 contains a circuit board 260 that supports and includes no more than one tuned circuit 256 (for single axis detection of low frequency magnetic pulses) and consisting of a capacitor 254 and an inductor 255. The tuned circuit 256 is configured for reception of low-frequency magnetic field signals, such as magnetic field signals (e.g., pulses) generated by the magnetic field generator of a PDS that is within a predefined maximum detection range of the FMM 221. When a low frequency magnetic field signal is received (e.g., from a vehicle PDS), it is interpreted by the processor 259. If the signal is valid, the FMM 221 responds (e.g., to the PDS of a vehicle) with a timed UHF transmission via the UHF transceiver 257 and the antenna 258. If the FMM 221 is a roadway marking FMM, for example, the response can include a signal that triggers the PDS to enter a roadway mode. If the FMM 221 is an aisle marking FMM, for example, the response can include a signal that triggers the PDS to enter an aisle mode and also includes the aisle ID corresponding to the aisle in which the FMM 221 is positioned. The frequency of the UHF transceiver may vary.

The FMM 221 is powered with a battery 253. In some examples, the battery 253 is positioned within a dedicated, modular housing 280 of the FMM 221. The housing 280 can house all components of the FMM 221 and is configured to be mounted to a structure, such as a rack of a facility. The housing of the FMM 221 can be a plastic enclosure with a removable battery lid 252 for easy replacement of the battery 253, e.g., every two years. Exact construction of the device enclosure may vary. To configure the specific functionality of the FMM 221 as described herein, in some examples a wireless UHF configuration tool 267 can be used. A configuration tool, such as the tool 267 can be used, e.g., to set the aisle identifier for the FMM 221, such that the microprocessor 259 can cause a data packet that includes the aisle identifier for that FMM to be generated and transmitted.

Referring to FIGS. 1-11, specific implementations of the described technology will now be described.

Various solutions for handling proximity detection on dock areas 107 and in very VNA areas 103 having very narrow aisles 120 defined by racks 122 are defined in the Frederick patents. Personal alarm devices (PADs) worn by personnel 110 that are commonly around forklifts or mobile equipment and may be hidden from view by racking, stacks of staged goods, or inside shipping containers are also described in the Frederick patents. A PAD alerts the wearer with audible and visual alerts. Meanwhile, the camera views available 804, 805 are helpful in scenarios when a pedestrian 111 steps into the roadway 104 out of the normal production area 105 into the path of a forklift 108. The proximity detection system would alert the forklift 108 operator of a person in proximity. This can also be applied to pedestrian 109 who is crossing the unguarded but marked walkway 106 on their way back to the office 102. If a forklift would enter this area, while the pedestrian 109 was in the walkway then the same alert method would be followed. This type of collision avoidance solution can work well in clear, unblocked paths. However, when there are obstructions in the fields of view detection may not be reliable. In addition visual data capture via cameras typically only works for unobstructed views in the camera view range 805 due to mounting constraints on the front cameras.

The solutions provided herein that incorporate one or more MRDs improve on these drawbacks of existing collision avoidance systems, improving likelihood of detection of an object with which collision is possible.

Since many facilities have limited visibilities in many locations, it is difficult for a vision system to fully function. PADs for personnel, on the other hand, are rarely around forklifts and may be difficult to manage. In contrast, the MRD 300 can be worn by these personnel 111, 109 in various ways such as on an armband 503. The MRD 300 allows the personnel to be detected by the PDS's 801 magnetic fields 806, 807, 808. The MRD has a long battery life of about a month, reduced cost due to simplified detection and its compact size. Yet, it is able to detect with normal personnel movements. In this scenario, the pedestrian's 111 MRD would alert the forklift 108 operator when it enters the walkway 106 and is anywhere in the full 360 degree detection range 809 around the forklift. The detection circuits 307, 311 operate in multiple detection axes for handling of various positions of the wearer relative to the PDS. Once the detection circuits 307, 311 detect a magnetic field pulse, the processor 304 determines the field intensity and if it is above a minimum threshold intensity (indicating the MRD is within the predefined MRD warning or danger zone of the PDS 801), the processor 304 will cause the MRD 300 to send a timed RF transmission 904 to the PDS using the transceiver 313 and antenna 314. This will tell the PDS to alert the forklift operator via warning modules 811, 812, or otherwise cause a collision avoidance action to occur.

Another specific implementation of the technology described herein will now be described.

As distribution facilities across the globe are being engineered to include advanced automation technologies including, automated forklifts, other automated vehicles, and even humanoid robots—the challenges of maintaining a safe and productive environment continue to increase. Although these autonomous vehicles are equipped with multiple technologies to avoid collisions, they at times fail. Additionally, detection of automated mobile robots can be challenging between different types of AMRs such as between an automated forklift and a rack transporting AMR. This can be a result of different operating systems, and the fact they are not innately aware of each other. If there is limited view or unexpected variables, they may not detect each other until it is too late to avoid a collision.

An additional challenge is for manned vehicles to be aware of the movements of these newer automated mobile objects now in the facility. This adds an additional burden and distraction on the forklift operators.

The facility 200 has the addition of a dedicated AGV area 209 that has racking 210 designed specifically for AMRs to store, sort, and transport this racking to picking stations. These AMRs 213, 209, 215, 219 are tasked with delivering product throughout a facility and are controlled by various guidance systems.

An automated forklift 208 equipped with a PDS on a roadway 204 is tasked with moving goods in the same areas as the AMRs. A manned forklift 220 equipped with a PDS is tasked with loading trailers 222 and driving on the same roadway 204 as the AMRs.

A collision potential is created between AMRs, automated forklifts, and manned forklifts. Vision technology cannot easily differentiate between AMRs carrying racks and stationary racks. AMR size and shape can also make it difficult to detect compared to other facility elements.

The AMR 215 sometimes carries goods to packing stations manned with personnel 217 who spend most of their time at those stations 216. The personnel 217 may leave their workstation for various reasons and should be equipped with the personnel version of the MRD 300 (e.g., in their pocket 504) to alert both a manned forklift or an automated forklift of potential collisions. This is demonstrated by the personnel 218 that is in the roadway. The MRD 300 will detect the PDS ping 900 using its tuned circuits 307, 311 and amplifiers 308, 312. The processor will then determine if the ping is above the set alert level and send a UHF response using the transceiver 313 and antenna 314 to the PDS in a defined time window. The PDS will receive the response in its time window 904.

The automated forklift will now have an additional input to make a decision to avoid collision. This also applies to personnel 211 leaving a defined work area 205 to go to the office 202 in a designated cross walk 206.

In the described environment, the automated forklift 208 must also be alerted to the AMR 209 leaving the production area 205 and backing toward the forklift 208 in the roadway 204. This can be done using the MRD 400 on the AMR 209. The MRD 400 is powered by the AMR with a battery backup 403. The MRD 400 will detect the PDS ping 900 using its tuned circuits 406, 411 and amplifiers 408, 412. The processor will then determine if the ping is above the set alert level and send a UHF response using the transceiver 413 and antenna 414 to the PDS in a defined time window. The PDS will receive the response in its window 904.

The automated forklift will now have an additional input to its control system to avoid collision. This can also be applied to the manned forklift 220; the same process between the PDS and MRD would occur and the result would be the operator receiving an alert that an MRD was present.

Automated forklifts may also have issues detecting AMRs when the automated forklift is exiting aisles of racking 203, since they cannot detect around the blind corners without the MRD.

The MRD also improves the tracking ability of the PDS systems installed on the forklifts 208,220. Management has the desire to understand which tractor-trailer 222 was loaded at what time and through which portal marked by a FMM 221. The mounting location of the MRD installation is important, and it must be placed in a secured location but out of the way of loading and unloading. The multiple detection axes provided by the multiple tuned circuits of the MRD 400 allow for some variation in mounting. Mounting under the floor of the trailer allows for access to power to charge the battery 403 when on the road so that when it is being loaded or unloaded it is powered. The MRD 223, 400 installed on a tractor-trailer 222 will detect the ping 900 of the PDS on the forklift 220 using its tuned circuit 406,411 and amplifiers 408, 412. The processor will then determine if the ping is above the set alert level and send a UHF response using the transceiver 413 and antenna 414 to the PDS in a defined time window. The PDS will receive the response in its window 904.

The PDS will store this information and associated ID in its memory. As the PDS passes a data relay with cellular connection, the data will be sent to the cloud. The web front end allows management to review these time stamped events and correlated the events to specific assets.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A proximity detection device of a vehicle, comprising:
a radio frequency receiver; and
a magnetic field generator configured to generate magnetic field pulses that can be detected by:
(i) a facility marker module (FMM) having no more than one tuned circuit for detecting the magnetic field pulses; and
(ii) a mobile response device (MRD) including a plurality of tuned circuits for detecting the magnetic field pulses,
wherein the radio frequency receiver is tuned to a first frequency band to listen during a first time window to receive a response to the magnetic field pulses from the FMM;
wherein the radio frequency receiver is tuned to a second frequency band to listen during a second time window to receive another response to the magnetic field pulses from the MRD, the second frequency band being different than the first frequency band; and
wherein the first time window and the second time window do not overlap.

2. The proximity detection device of claim 1, wherein the second time window is subsequent to the first time window.

3. The proximity detection device of claim 1, wherein the second time window begins when the first time window ends.

4. A traffic management system, comprising:
the proximity detection device of claim 1;
the FMM; and
the MRD,
wherein the plurality of tuned circuits includes no more than two tuned circuits.

5. The system of claim 4,
wherein the FMM is affixed to a fixed structure that defines an aisle of a facility; and
wherein the MRD is mounted to an object that moves relative to the aisle.

6. The system of claim 5, wherein the MRD is mounted to a person.

7. The system of claim 5, wherein the MRD is mounted to a tractor-trailer.

8. The system of claim 5, wherein the MRD is mounted to an autonomous mobile robot (AMR) or to an autonomous vehicle (AV), the AMR or the AV including an onboard power supply that provides power to the MRD.

9. The system of claim 4, wherein the MRD includes a battery operatively coupled to a hibernation circuit.

10. The system of claim 4,
wherein the proximity detection device is configured to determine, based on a signal received from the FMM, whether the vehicle is in the same aisle as another vehicle; and
wherein the proximity detection device is configured to determine, based on another signal received from the MRD, whether the proximity detection device and the MRD are within predefined distances of each another.

11. The system of claim 10, wherein the system is configured to initiate a collision avoidance action when:
(i) the proximity detection device determines that the vehicle and the another vehicle are in the same aisle; or
(ii) the proximity detection device determines that the proximity detection device and the MRD are within a predefined distance of each other.

12. The system of claim 11, wherein the collision avoidance action includes one or more of:
sounding an alarm; and
causing the vehicle or the another vehicle to slow down or change a direction of motion.

13. The system of claim 4, wherein the MRD includes an exterior housing that houses the plurality of tuned circuits and a battery, the exterior housing occupying a volume of less than 8 cubic inches.

14. The system of claim 4, wherein the MRD includes an exterior housing that houses the plurality of tuned circuits and a battery, the exterior housing occupying a volume of less than 6 cubic inches.

15. The system of claim 4, wherein the MRD includes an exterior housing that houses the plurality of tuned circuits and a battery, the exterior housing occupying a volume of less than 5 cubic inches.

16. The system of claim 15, wherein the exterior housing includes a mounting structure for mounting the exterior housing to a mobile object, the mounting structure including one or more of an adhesive, a clip, a strap, a pin, and a hole for receiving a fastener.

17. The system of claim 5, wherein the FMM is configured to transmit a signal to the proximity detection device only when the proximity detection device is positioned in the aisle, the signal including an aisle identifier identifying the aisle.

18. The system of claim 17, wherein the proximity detection device is configured to:
store the aisle identifier; and
transmit the aisle identifier to another proximity detection device mounted to another vehicle that is within a predefined range of the proximity detection device.

19. The system of claim 18, comprising the another proximity detection device,
wherein the another proximity detection device is configured to compare the aisle identifier to another aisle identifier stored by the another proximity detection device; and
wherein when the aisle identifier and the another aisle identifier are the same, at least one of the proximity detection device or the another proximity detection device is configured to generate a collision alert signal.

20. The system of claim 19,
wherein the proximity detection device is configured to engage, and disengage from, a guidance system associated with the aisle, the guidance system being configured to inhibit the vehicle from moving away from a guide path within the aisle when the proximity detection device is engaged to the guidance system; and
wherein the FMM is configured to transmit the signal including the aisle identifier identifying the aisle to the vehicle only when the vehicle is positioned in the aisle and when the proximity detection device is engaged to the guidance system.

21. A vehicle, comprising:
the proximity detection device of claim 1, the proximity detection device being mounted to a body of the vehicle; and
a visual detection system for visually detecting an object within a visual detection zone of vehicle, the visual detection system including a camera mounted to the body of the vehicle.

22. A traffic management system configured for a facility having a plurality of aisles and a plurality of vehicles, comprising:
a plurality of proximity detection devices mounted to different vehicles of the plurality of vehicles;
a plurality of facility marker modules (FMMs) mounted to different aisles of the plurality of aisles, each FMM including no more than one tuned circuit, a processor and a UHF transceiver, each FMM being configured to transmit signals using the processor and the UHF transceiver in response to receiving, by the tuned circuit, magnetic field pulses generated by one of the plurality of proximity detection devices; and
a plurality of mobile response devices (MRDs), each MRD being mounted to a person or to an autonomous mobile robot, each MRD including a plurality of tuned circuits for detecting the magnetic field pulses,
wherein the plurality of proximity detection devices are configured to determine, based on signals received from the plurality of FMMs, whether the different vehicles are in the same aisle of the plurality of aisles; and
wherein the plurality of proximity detection devices are configured to determine, based on other signals received from the plurality of MRDs, whether the plurality of proximity detection devices and the plurality of MRDs are within predefined distances of one another.

23. The system of claim 22, wherein the system is configured to initiate a collision avoidance action when:
(i) the plurality of proximity detection devices determine that two of the different vehicles are in the same aisle of the plurality of aisles; or
(ii) the plurality of proximity detection devices determine that one of the plurality of proximity detection devices and one of the plurality of MRDs are within a predefined distance of each other.

24. The system of claim 23, wherein the collision avoidance action includes one or more of:
sounding an alarm; and
causing one of the plurality of vehicles to slow down or change a direction of motion.

25. A mobile response device (MRD), comprising:
a housing defining an interior volume of the housing;
a plurality of tuned circuits positioned in the interior volume and configured to detect magnetic field pulses along multiple, perpendicular axes;
a radio frequency transceiver operatively coupled to the plurality of tuned circuits and positioned within the interior volume; and
a battery positioned within the interior volume and operatively coupled to the plurality of tuned circuits and to the radio frequency transceiver to provide power thereto,
wherein the housing occupies a volume of less than 8 cubic inches.

26. The MRD of claim 25, wherein the housing occupies a volume of less than 6 cubic inches.

27. The MRD of claim 25, wherein the housing occupies a volume of less than 5 cubic inches.

28. The MRD of claim 25, wherein the housing includes a mounting structure for mounting the housing to a mobile object, the mounting structure including one or more of an adhesive, a clip, a strap, a pin, and a hole for receiving a fastener.

29. The MRD of any claim 25, wherein a total weight of the MRD is less than 5 ounces.
